(19) United States
(12) Patent Application Publication
(10) Pub. No.: US 2006/0256192 A1
(43) Pub. Date: Nov. 16, 2006

(54) Endoscope processor, computer program product, and endoscope system

(75) Inventors: Kohei Iketani, Saitama (JP); Mitsufumi Fukuyama, Hyogo (JP)

Correspondence Address: GREENBLUM & BERNSTEIN, P.L.C., 1950 ROLAND CLARKE PLACE, RESTON, VA, 20191, US

(73) Assignee: PENTAX Corporation, Tokyo (JP)

(21) Appl. No.: 11/431,567

(22) Filed: May 11, 2006

(30) Foreign Application Priority Data
May 12, 2005 (JP) P2005-139597

(51) Int. Cl. H04N 7/18

(52) U.S. Cl. 348/65

(57) ABSTRACT

An endoscope processor comprising an image signal receiver, a calculator, an amplifier, and a noise reduction unit, is provided. The image signal receiver receives a raw image signal. The image signal is generated by an imaging device when the imaging device captures an optical image of an object. The calculator calculates a first gain. The first gain is used for amplifying the raw image signal. The amplifier amplifies the raw image signal based on the first gain, and then the amplified image signal is generated. The noise reduction unit reduces noise included in the amplified image signal according to the first gain, and then the noise-reduced signal is generated.

### BACKGROUND OF THE INVENTION

1. Field of the Invention

The present invention relates to an endoscope system that maintains a received image at a steady brightness and an endoscope processor that performs noise reduction on this image.

2. Description of the Related Art

An electronic endoscope, having an imaging device at an end of the insert tube, is used for medical or industrial purposes. With an electronic endoscope unlike with a fiberscope, the brightness of an image can be controlled by amplifying the image signal generated by an imaging device. However, noise that is included in the image signal is also amplified by amplifying the imaging signal. Such noise can be reduced by a noise reduction filter.

The image signal of an endoscope is usually amplified by an AGC (Auto Gain Controller) so that the brightness of the whole image can be kept stable. The AGC amplifies the image signal by a gain that is calculated automatically. Noise reduction is insufficient when the gain is high. Consequently, a displayed image has noticeable noise. On the other hand, noise reduction is excessive when the gain is low. Consequently, a displayed image is over-smoothed since noise reduction is generally carried out by smoothing.

### SUMMARY OF THE INVENTION

Therefore, an object of the present invention is to provide an endoscope processor and an electronic endoscope system that can reduce noise included in image signal even though the image signal is amplified by the auto gain controller.

According to the present invention, an endoscope processor comprising an image signal receiver, a calculator, an amplifier, and a noise reduction unit, is provided. The image signal receiver receives a raw image signal. The image signal is generated by an imaging device when the imaging device captures an optical image of an object. The calculator calculates a first gain. The first gain is used for amplifying the raw image signal. The amplifier amplifies the raw image signal based on the first gain, and then the amplified image signal is generated. The noise reduction unit reduces noise included in the amplified image signal according to the first gain, and then the noise-reduced signal is generated.

Further the calculator calculates the first gain. That sets the brightness of a displayed image to be a predetermined brightness. The displayed image corresponds to the noise-reduced signal.

Further the raw image signal has a plurality of pixel signals generated by a plurality of pixels forming a receiving surface of the imaging device. The calculator generates the luminance signal. The luminance signals correspond to the pixel signals. The calculator should calculate the first gain based on a plurality of the luminance signals.

Further the calculator obtains the first gain by dividing a predetermined luminance by either the average luminance or the maximum luminance. The average luminance or the maximum luminance are obtained in either case from a plurality of luminance values. The luminance values corresponds to the luminance signals

### BRIEF DESCRIPTION OF THE DRAWINGS

The objects and advantages of the present invention will be better understood from the following description, with reference to the accompanying drawings in which:

FIG. 1 is a block diagram showing the internal structure of an electronic endoscope system having an endoscope processor of an embodiment of the present invention;

FIG. 2 illustrates a moving average filter of the embodiment;

FIG. 3 is a flowchart to explain the noise reduction process;

FIG. 4 is a block diagram showing the internal structure of another noise reduction filter circuit having a spatial filter;

FIG. 5 represents the outline of the structure of a time filter;

FIG. 6 is a block diagram showing the outline of the internal structure of a noise reduction filter circuit having a time filter; and

FIG. 7 is a block diagram showing the outline of the internal structure of another noise reduction filter circuit having a time filter.

### DESCRIPTION OF THE PREFERRED EMBODIMENTS

The present invention is described below with reference to the embodiment shown in the drawings.

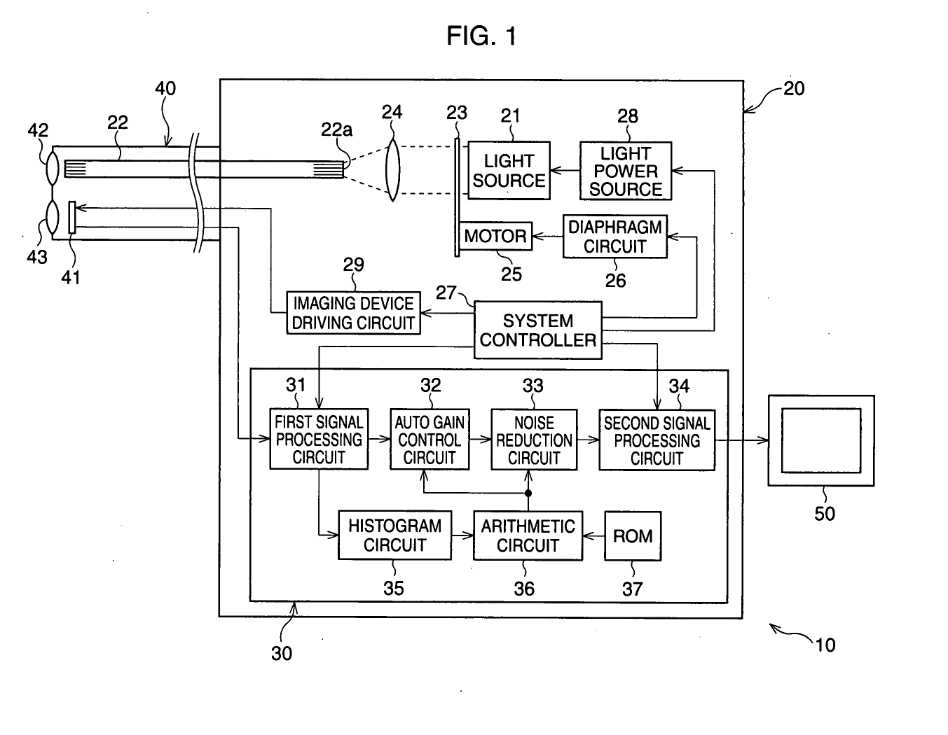

In the FIG. 1, an electronic endoscope system 10 comprises an endoscope processor 20, an endoscope 40, and a monitor 50. The endoscope processor 20 is connected to the endoscope 40 and the monitor 50 via connecters (not depicted).

A light source 21 for illuminating an object (not depicted) is housed in the endoscope processor 20. The light that the light source 21 emits is irradiated to the desired object via the light guide 22 housed in the endoscope 40.

An optical image of the illuminated object is received by an imaging device 41, such as CCD, mounted in the endoscope 40. The photographed image is sent as the raw image signal to the endoscope processor 20. The endoscope processor 20 carries out some predetermined signal processing for the raw image signals. The raw image signal, having had the predetermined processes carried out, is sent to the monitor 50. An image, corresponding to the raw image signal sent to the monitor 50, is displayed on the monitor 50.

The diaphragm 23 and the condenser lens 24 are mounted in the optical path of the light emitted by the light source 21 to the incident end 22a of the light guide 22. The light, which is composed of almost all parallel light beams emitted by the light source 21, is made incident on the incident end 22a, through the condenser lens 24. The condenser lens 24 condenses the light for the incident end 22a.

The intensity of the light made incident on the incident end 22a is adjusted by driving the diaphragm 23. The diaphragm 23 is driven by a motor 25. Movement of the motor 25 is controlled by the diaphragm circuit 26. The diaphragm circuit 26 is connected to a first signal processing circuit 31 via a system controller 27. The first signal processing circuit 31 detects the amount of light received for a received image based on the raw image signals generated by the imaging device 41. The diaphragm circuit 26 calculates a driving quantity of the motor 25 based on the amount of light received.

Power for the light source 21 is supplied by the light power source 28. The light power source 28 is connected to the system controller 27. The system controller 27 switches the light source 21 on and off.

Further, the system controller 27 outputs a necessary timing signal for driving the imaging device 41 to an imaging device driving circuit 29. The imaging device 41 is driven by the imaging device driving circuit 29, and then the imaging device 41 generates a raw image signal corresponding to a received image.

Further, the system controller 27 controls movement of the whole endoscope processor 20. A video signal processing circuit 30 is controlled by the system controller 27, as described later.

The light made incident on the incident end 22a is transmitted to an out end (not depicted) by the light guide 22. The transmitted light illuminates a peripheral area nearby the head end of the insert tube (not depicted) through a diffuser lens 42. An optical image of the illuminated object is received by the imaging device 41 through an object lens 43.

A frame of a raw image signal, corresponding to an optical image received by the imaging device 41, is generated by the imaging device 41. The raw image signal is sent to the video signal processing circuit 30 housed in the endoscope processor 20.

The video signal processing circuit 30 comprises a first signal processing circuit 31, an auto gain control circuit 32, a noise reduction circuit 33, a second signal processing circuit 34, a histogram circuit 35, an arithmetic circuit 36, and a ROM 37.

The raw image signal generated by the imaging device 41 is sent to the first signal processing circuit 31. The first signal processing circuit 31 carries out the predetermined signal processing, for example, color balance processing, contrast control processing, A/D conversion processing, and so on, for the raw image signal. The raw image signal that the predetermined signal processing is carried out on is sent to the auto gain control circuit 32 and the histogram circuit 35.

The histogram circuit 35 generates histogram data based on the raw image signal. The raw image signal comprises plurality of pixel signals that are in accordance with luminance generated by plurality of pixels forming a receiving surface of the imaging device 41. The histogram data corresponds to a histogram of luminance. An average luminance is calculated from the received image based on the histogram of luminance. The average luminance is sent as a signal to the arithmetic circuit 36.

The arithmetic circuit 36 calculates a first gain used for amplifying the raw image signal. The ROM 37 stores predetermined luminance signal used for first gain calculation. Predetermined luminance, corresponding to the predetermined luminance signal, is set for middle luminance value of luminance that can be displayed on the monitor 50. The arithmetic circuit 36 divides the predetermined luminance by the average luminance, and then the first gain is calculated. The first gain is sent as signal to the auto gain control circuit 32 and the noise reduction circuit 33.

The auto gain control circuit 32 generates an amplified image signal by amplifying the raw image signal by the first gain. The amplified image signal is sent to the noise reduction circuit 33.

The noise reduction circuit 33 is a moving average filter circuit.

The filtering process carried out by the moving average filter circuit is outlined as follows. A pixel for which the filtering process is carried out for pixel signal is named a focused pixel, hereinafter referred to as an FP. Any pixels surrounding the FP are named surrounding pixels, hereinafter referred to as SPs. The FP and SP form a filter-area. The FP is at the center of the filter-area. A signal level of the pixel signal at the FP is averaged by the filtering process based on pixel signals at pixels in a filter-area. The filtering process for an amplified image signal is achieved by applying this filtering process to each pixel, in successive order, thereby creating a composite image made up of individual FP's

The noise reduction circuit 33 is a moving average circuit of which filter-area is changeable according to the first gain. Consequently, the noise reduction level gets higher when the filter-area is broadened. Then, the noise level is greatly reduced, and the entire image is greatly smoothed. Alternatively the noise reduction level gets lower when the filter-area is narrowed. Then the noise level is reduced slightly, and the entire image is smoothed slightly.

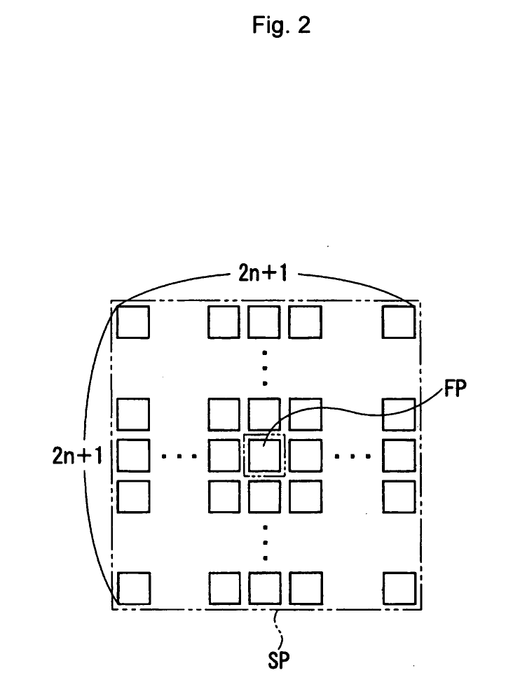

As shown in FIG. 2, the FP is in the center of the filter-area. In addition, there are SPs of (2n+1) rows and (2n+1) columns surrounding the FP. When the first gain is high, the value of “n” is set to be higher. In this case the pixel signals of more SPs are used for noise reduction at the FP. On the other hand, when the first gain is lower, then the value of “n” is set to be lower. In this case the pixel signals of fewer SPs are used for noise reduction at the FP.

The noise reduction circuit 33 carries out a filtering process for the amplified image signal, and then a noise-reduced signal is generated. The noise-reduced signal is sent to the second signal processing circuit 34.

The second signal processing circuit 34 carries out some predetermined signal processing, including a D/A conversion process, for the noise-reduced signal. Further, the noise-reduced signal is converted to the complex video signal. The complex video signal is sent to the monitor 50. An image corresponding to the complex video signal is displayed on the monitor 50 as described above.

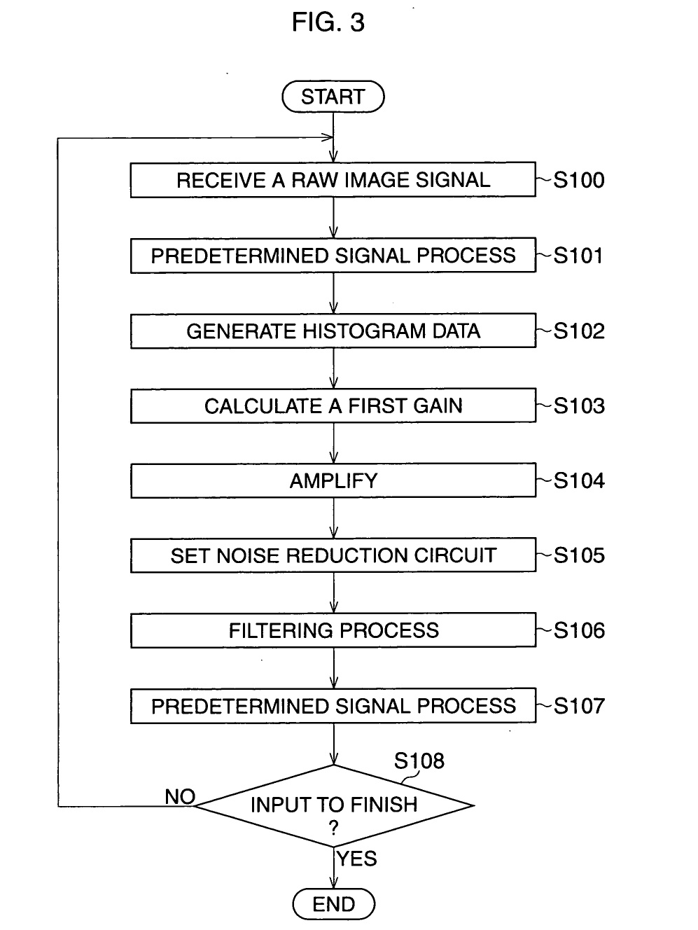

Next, noise reduction processes carried out by the endoscope processor 20 are explained below using the flowchart of FIG. 3.

The noise reduction process of this embodiment begins when the imaging device 41 is activated and a raw image signal is generated.

At step S100, the endoscope processor 20 receives a raw image signal generated by the imaging device 41. Then, the process proceeds to step S101. At step S101, the predetermined signal processes, such as color balance process and contrast control process, are carried out for the raw image signal by the first signal processing circuit 31.

At step S102, histogram data is generated based on the raw image signal, and the process proceeds to step S103. At step S103, a first gain is calculated based on the histogram data, generated at step S102, and the predetermined luminance signal, stored in the ROM 37. At step S104, the raw image signal is amplified by the first gain, and then an amplified image signal is generated.

At step S105, the noise reduction circuit 33 is set so that the noise reduction circuit 33 can reduce the noise amplified by the first gain. In the setting of noise reduction circuit 33, the number of the SPs is controlled according to the first gain. The number of SPs is increased in order to reduce more noise when the first gain is higher (thereby avoiding too much noise). The number of SPs is decreased in order to reduce less noise when the first gain is lower (thereby avoiding over-smoothing).

The process proceeds to step S106 after setting the noise reduction circuit 33. At step S106, the filtering process is carried out for the amplified image signal by the noise reduction circuit 33, and then a noise-reduced signal is generated. At step S107, the predetermined signal processes are carried out for the noise-reduced signal by the second signal processing circuit 34. At step S108, a decision is made as to whether there is input to finish an observation by the endoscope system 10. If there is input to finish, then the noise reduction process finishes; otherwise, the process returns to step S100. The processes from step S100 to step S108 are repeated until there is the input to finish.

In the first embodiment, insufficient noise reduction and over-smoothing can both be prevented as the brightness of the image displayed on a monitor is kept stable. The noise component included in the amplified image signal becomes high when the first gain, used for the amplifying at the auto gain control circuit 32, is high. However, such high noise can be reduced sufficiently since the noise reduction level is set higher according to the size of the first gain. In particular, even if the image signal is feeble (for example, in the case of the image signal generated by an autofluorescence endoscope) and is amplified by large gain, a resulting filtered image where there is no noticeable noise can be displayed on a monitor. On the other hand, the noise component included in the amplified image signal becomes low when the first gain is low. In this case, over-smoothing by the filtering process is prevented since the noise reduction level is set lower according to the size of the first gain.

The noise reduction circuit 33 changes the noise reduction level by changing the number of SPs in the above embodiment. However, this invention is adaptable to any noise reduction filter that can control the noise reduction level according to the first gain.

For example, any of the noise reduction filters described below may be replaced with the noise reduction circuit 33 in the first embodiment.

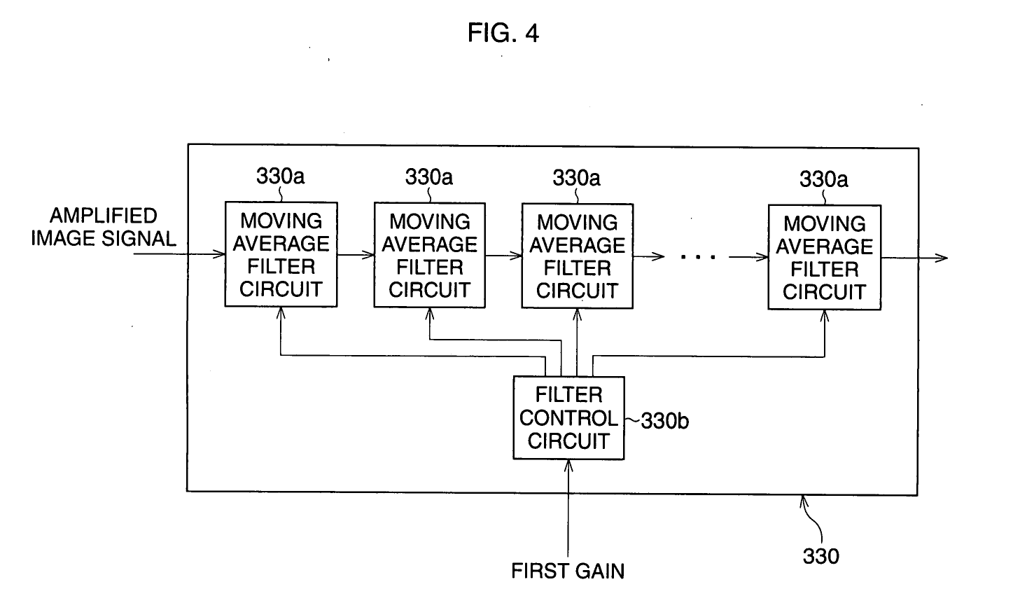

As an example in FIG. 4, the noise reduction circuit 330 can control the noise reduction level according to the first gain. In this example, the noise reduction circuit 330 comprises a plurality of moving average filter circuits 330a and a filter control circuit 330b.

The moving average filter circuits 330a are connected in a series. Each of the moving average filter circuits 330a from the second to the last can reduce noise from the noise-reduced signal from the filtering process from the previous moving average filter circuit(s) 330a. Unlike in the case of the noise reduction circuit 33 in the first embodiment, the filter-area of the moving average filter circuit 330a may be fixed.

The operation of the noise reduction circuit 330 is explained below. The first gain is sent as a signal to the filter control circuit 330b. The filter control circuit 330b sends an ON signal or an OFF signal to each of the moving average filter circuits 330a based on the first gain. The moving average filter circuits 330a that receive the ON signal carry out the filtering process for the noise-reduced signal input from the previous moving average filtering circuit(s) 330a, thereby reducing the noise-level. On the other hand, the moving average filter circuit(s) 330a that receive the OFF signal pass and output the noise-reduced signal without carrying out any filtering process. The higher the first gain, the more moving average filter circuit(s) 330a receive the ON signal from the filter control circuit 330b. On the other hand, the lower the first gain, the more moving average filter circuits 330a receive the OFF signal from the filter control circuit 330b. In this manner, the noise reduction circuit 330 can change the noise reduction level according to the first gain.

A moving average filter is used for the noise reduction circuit 33, 330. However, a spatial filter that reduces noise based on the FP and SPs may also be used. For example, a median filter may be used for the noise reduction filter instead of a moving average filter.

A spatial filter is used for the noise reduction circuit 33, 330, as described above. Further, a time filter may also be used. For example, low frequency noise that is difficult to reduce with a spatial filter can be reduced sufficiently with a time filter.

A time filter and a noise reduction filter using a time filter are explained briefly below.

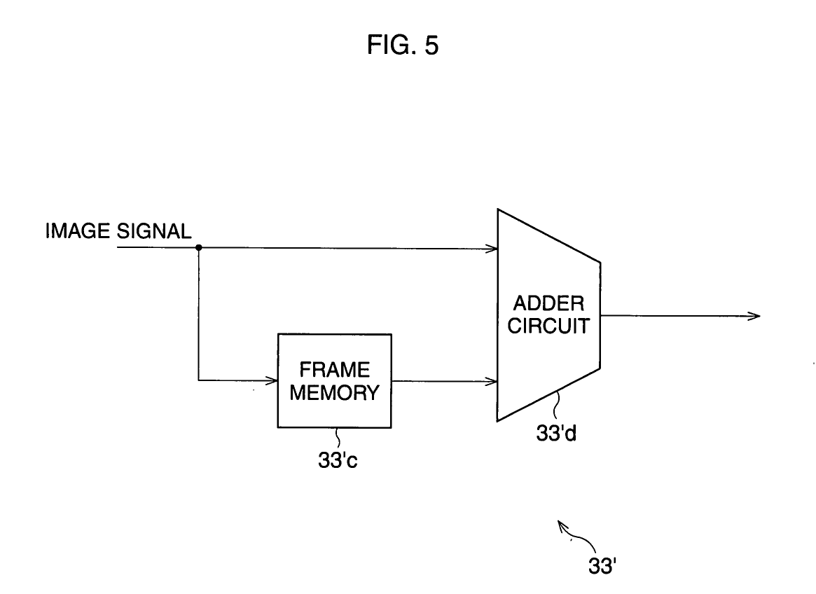

A time filter 33′ comprises a frame memory 33′c and an adder circuit 33′d, as shown in FIG. 5. An image signal input to a time filter is sent to the frame memory 33′c and the adder circuit 33′d. The frame memory stores the image signal. The frame memory 33′c sends the stored image signal to the adder circuit 33′d at the same time as when the adder circuit 33′d receives the image signal of the next frame. The adder circuit 33′d calculates the average of the latest image signal and the stored image signal of the previous frame, and then the noise included in the latest image signal is reduced.

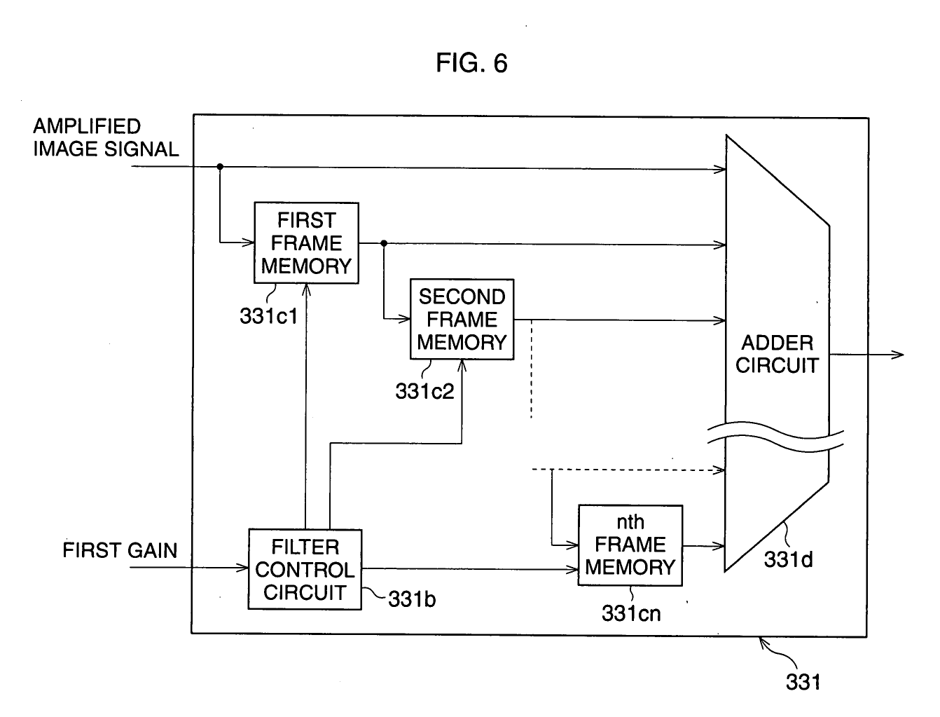

A noise reduction circuit 331 shown in FIG. 6 comprises first, second, . . . , and nth frame memories 331c1, 331c2, . . . , 331cn, an adder circuit 331d, and a filter control circuit 331b. The first frame memory 331c1 stores the first image signal generated at the previous frame timing of the 0th (latest) image signal. The second frame memory 331c2 stores the second image signal generated at the previous frame timing of the first image signal. Similarly, the nth frame memory 331cn stores the nth image signal generated at the previous frame timing of the (n−1)st image signal stored in the (n−1)st frame memory (not depicted). The first gain is sent to the filter control circuit 331b as a signal. The filter control circuit 331d sends an ON signal or an OFF signal to each of the frame memories 331c1˜331cn based on the first gain. The frame memory that receives the ON signal outputs the stored image signal to the adder circuit 331d. On the other hand, the frame memory that receives the OFF signal stops outputting the stored image signal to the adder circuit 331d. The higher the first gain, the more frame memories output the stored image signal to the adder circuit 331d. On the other hand, the lower the first gain, the fewer frame memories output the stored image signal to the adder circuit 331d. The noise reduction level is raised by increasing the number of image signals used for calculation by the adder circuit 331d. Alternatively, the noise reduction level is lowered by decreasing the number of image signals used for calculation by the adder circuit 331d. Accordingly, the noise reduction circuit 331 can also change the noise reduction level according to the first gain.

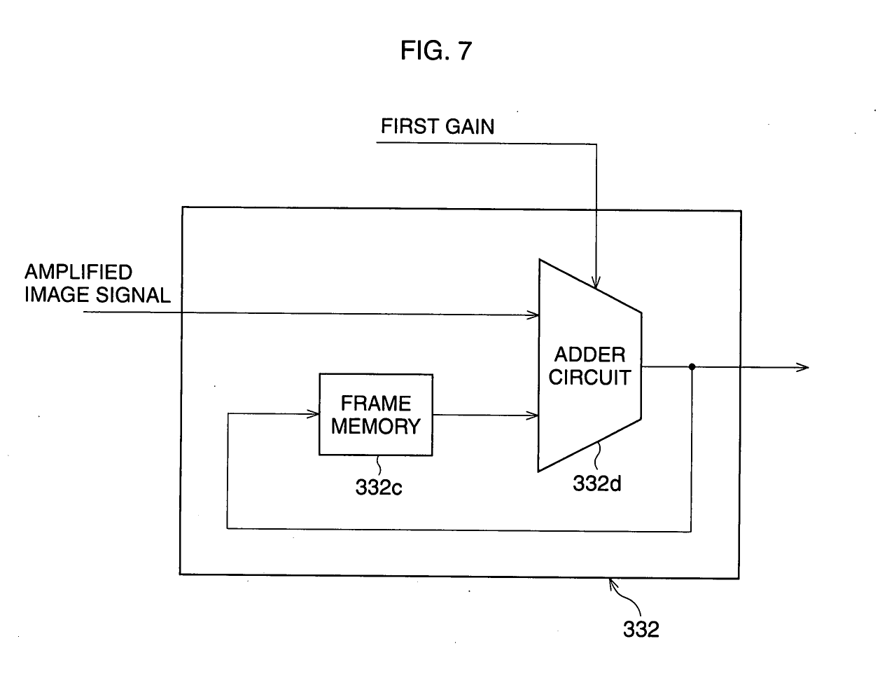

Next, another noise reduction filter using a time filter is described below, with reference to FIG. 7.

A noise reduction circuit 332 comprises a frame memory 332c and an adder circuit 332d. The auto gain control circuit 32 (shown in FIG. 1) is connected to an input terminal of the adder circuit 332d. The amplified image signal is sent from the auto gain control circuit 32 to the adder circuit 332d. An input terminal of the frame memory 332c is connected to an output terminal of the adder circuit 332d. An output terminal of the frame memory 332c is connected to another input terminal of the adder circuit 332d. The noise-reduced signal output from the adder circuit 332d is stored by the frame memory 332c. The noise-reduced signal stored by the frame memory 332c is input to the adder circuit 332d.

The adder circuit 332d calculates a weighted average of the amplified image signal and the noise-reduced signal from frame memory 332c, and thereby noise is reduced in the amplified image signal. The noise-reduced signal is sent to the second image signal processing circuit 34. In addition, the noise-reduced signal is sent to and stored by the frame memory 332c, as described above.

The first gain is sent to the adder circuit 332d as a signal. The higher the first gain, the more weight is given to the noise-reduced signal from frame memory 332c in the calculation of the weighted average at the adder circuit 332d. The noise reduction level rises as the weight of the noise-reduced signal is increased. Accordingly, the noise reduction circuit 332 can change the noise reduction level according to the first gain.

A spatial filter/time filter was used for the noise reduction circuits 33, 330, 331, 332. However, any filters that reduce noise may be used instead as well.

The arithmetic circuit 36 calculates the first gain with the average luminance of the raw image signal in the above embodiment. However, the arithmetic circuit 36 may also calculate the first gain with the maximum luminance of the raw image signal, instead. Further, the arithmetic circuit 36 may calculate the first gain based on any other luminance of the raw image signal given in the luminance histogram based on the raw image signal.

The arithmetic circuit 36 calculated the first gain with the average luminance of the raw image signal in the above embodiment. However, the arithmetic circuit 36 may calculate the first gain to be such a value as to specify the brightness of an entire image displayed on monitor 50 to be of any specific brightness.

The above embodiment can be implemented by installing a program for noise reduction onto an all purpose endoscope processor. The program for noise reduction comprises a controller code segment, a calculator code segment, an amplifier code segment, and a noise reduction code segment. The controller code segment causes a CPU (not depicted) to activate an image signal receiver of the all purpose endoscope processor so that the image signal receiver receives a raw image signal. The calculator code segment causes the CPU to calculate the first gain. The amplifier code segment causes the CPU to generate the amplified image signal. The noise reduction code segment causes the CPU to generate the noise-reduced signal.

Although the embodiments of the present invention have been described herein with reference to the accompanying drawings, obviously many modifications and changes may be made by those skilled in this art without departing from the scope of the invention.

The present disclosure relates to subject matter contained in Japanese Patent Application No. 2005-139597 (filed on May 12, 2005), which is expressly incorporated herein, by reference, in its entirety.

1. An endoscope processor, comprising:
an image signal receiver that receives a raw image signal, generated by an imaging device when said imaging device captures an optical image of an object;
a calculator that calculates a first gain used for amplifying said raw image signal;
an amplifier that generates amplified image signal by amplifying said raw image signal based on said first gain; and
a noise reduction unit that generates noise-reduced signal by reducing noise included in said amplified image signal according to said first gain.

2. An endoscope processor according to claim 1, wherein said calculator calculates said first gain, thereby setting the brightness of a displayed image, corresponding to said noise-reduced signal, to be a predetermined brightness.

3. An endoscope processor according to claim 1, wherein said raw image signal has a plurality of pixel signals generated by a plurality of pixels, which form the receiving surface of said imaging device, said calculator generates the luminance signal corresponding to said pixel signals, and said calculator calculates said first gain based on a plurality of said luminance signals.

4. An endoscope processor according to claim 3, wherein said calculator obtains said first gain by dividing a predetermined luminance by either the average luminance or the maximum luminance obtained in either case from a plurality of luminance values corresponding to said luminance signal

5. An endoscope processor according to claim 1, wherein said imaging device comprises some pixels generating pixel signals in accordance with a received light amount on receiving surface, said noise reduction unit is a spatial filter, which carries out a noise reduction step for said pixel signal generated by a focused-pixel based on pixel signal(s) generated by surrounding-pixel(s) that is arranged around said focused-pixel, and said noise reduction unit carries out a number of said noise reduction steps to reduce noise included in said amplified image signal in a noise reduction process.

6. An endoscope processor according to claim 5, wherein said noise reduction unit increases the number of said surrounding pixels in accordance with increasing said first gain.

7. An endoscope processor according to claim 5, wherein said noise reduction unit increases the number of times that said noise reduction process is applied to reduce noise included in said amplified image signal in accordance with increasing said first gain.

8. An endoscope processor according to claim 5, wherein said spatial filter is a moving average filter or a median filter.

9. An endoscope processor according to claim 1, wherein said noise reduction unit reduces noise included in the current amplified image signal based on past amplified image signal(s) generated by said amplifier before generating said current amplified image signal.

10. An endoscope processor according to claim 9, wherein said noise reduction unit reduces noise included in said current amplified image signal by averaging said current amplified image signal and said past amplified image signal(s), and said noise reduction unit increases the number of said past amplified image signals in accordance with increasing said first gain.

11. An endoscope processor according to claim 1, wherein said noise reduction unit has a memory to store said noise-reduced signal, said noise reduction unit reduces noise included in the current amplified image signal by calculating weighted average of said current amplified image signal and said stored noise-reduced signal, and said noise reduction unit increases weight for said stored noise-reduced signal in accordance with increasing said first gain.

12. An endoscope system, comprising:
an electronic endoscope having an imaging device that generates a raw image signal when said imaging device captures an optical image of an object;
a calculator that calculates a first gain used for amplifying said raw image signal;
an amplifier that generates amplified image signal by amplifying said raw image signal based on said first gain;
a noise reduction unit that generates noise-reduced signal by reducing noise included in said amplified image signal according to said first gain; and
a monitor that displays an image corresponding to said noise-reduced signal.

13. A computer program product, comprising:
a controller that activates an image signal receiver so that said image signal receiver receives a raw image signal, generated by an imaging device when said imaging device captures an optical image of an object;
a calculator that calculates a first gain used for amplifying said raw image signal;
an amplifier that generates amplified image signal by amplifying said raw image signal based on said first gain; and
a noise reduction unit that generates noise-reduced signal by reducing noise included in said amplified image signal according to said first gain.
